(19) United States
(12) Patent Application Publication
(10) Pub. No.: US 2017/0142779 A1
(43) Pub. Date: May 18, 2017

(54) Surface Covering For Melting Ice And Snow

(71) Applicant: Jason Mitchell, Trinity, FL (US)

(72) Inventor: Jason Mitchell, Trinity, FL (US)

(21) Appl. No.: 14/940,315

(22) Filed: Nov. 13, 2015

(51) Int. Cl. H05B 3/36; H05B 3/34; H05B 1/02

(52) U.S. Cl. CPC H05B 3/36; H05B 1/0244; H05B 3/342; H05B 2203/026; H05B 2214/02

(57) ABSTRACT

A surface covering for melting ice or snow includes opposing panels of textile material that are joined together to define a mat structure having plurality of adjacent elongate chambers. A melting composition is disposed in the plurality of chambers and is activated to melt ice and snow contacting the mat. In another aspect, an apparatus for melting ice or snow includes a frame having a peripheral border that substantially circumscribes an interior area, and a mat removably received within the interior area of the frame. The mat includes a textile material that defines at least one elongate chamber. A melting composition is disposed in the at least one chamber.

### TECHNICAL FIELD

The present invention relates generally to surface coverings, and more particularly to a surface covering for melting ice and/or snow.

### BACKGROUND

The accumulation of ice and snow on driveways, walkways, steps, and other walking surfaces presents a slipping hazard to pedestrians. Aside from using manual labor to remove ice and snow from such surfaces, using shovels for example, conventional methods of treating ice and snow have involved the application of rock salt or other ice and snow melting chemicals in particulate form. Such ice and snow melting chemicals have generally been applied to affected surfaces by hand or by using a broadcast spreader to facilitate melting the ice and snow entirely, or to at least facilitate removal with a shovel. Other devices have been proposed that facilitate melting ice and snow using electric power to generate heat to melt the ice and snow.

A need exists for an improved device that facilitates melting ice and snow and which can be quickly and easily applied to a desired surface and which does not require external power.

### SUMMARY

The present invention provides a mat that facilitates melting ice and snow that has accumulated on walking surfaces or other areas. While the invention will be described in connection with certain embodiments, it will be understood that the invention is not limited to these embodiments. On the contrary, the invention includes all alternatives, modifications and equivalents as may be included within the spirit and scope of the present invention.

According to one aspect, an apparatus for melting ice or snow includes a frame having a peripheral border that substantially circumscribes an interior area, and a mat removably received within the interior area of the frame. The mat comprises a textile material that defines at least one elongate chamber. A melting composition is disposed in the at least one chamber and is activated to melt ice and snow upon contact with the mat.

In one embodiment, the mat comprises opposing panels of material that are stitched together to define a plurality of adjacent elongate chambers. In another embodiment, the mat comprises a plurality of elongate tubes, each tube defining a respective elongate chamber for receiving the melting composition therein. The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of an exemplary embodiment of a mat in accordance with the principles of the present disclosure.

FIG. 1A is a perspective view of another exemplary mat in accordance with the principles of the present disclosure.

FIG. 2 is perspective view of an exemplary apparatus for melting ice and snow, including the mat of FIG. 1 and depicting the apparatus in use.

FIG. 3 is an exploded perspective view of the apparatus of FIG. 2.

FIG. 3A is an exploded perspective view, similar to FIG. 2, depicting another embodiment of an apparatus for melting ice and snow in accordance with the principles of the present disclosure.

FIG. 4 is a perspective view of an exemplary tube used in the exemplary mat depicted in FIGS. 1-3.

FIG. 5 is a front view of the tube of FIG. 4.

FIG. 6 is a top plan view of the tube of FIG. 4.

FIG. 7 is an enlarged detail view of the encircled portion of the tube depicted in FIG. 5.

FIG. 8 is an enlarged detail view of the encircled portion of the tube depicted in FIG. 6.

FIG. 9 is a perspective view of the mat of FIG. 1, with portions hidden to illustrate details of the mat.

FIG. 10 is cross-sectional view of the mat of FIG. 1, taken along line 10-10.

FIG. 11 is a perspective view of another exemplary embodiment of a mat in accordance with the principles of the present disclosure.

FIG. 12 is a front view of the tube of FIG. 11.

FIG. 13 is a top plan view of the tube of FIG. 11.

FIG. 14 is an enlarged detail view of the encircled portion of the tube depicted in FIG. 12.

FIG. 15 is an enlarged detail view of the encircled portion of the tube depicted in FIG. 13.

FIG. 16A is an enlarged cross-sectional detail view illustrating an exemplary arrangement for attaching a mat to a frame in accordance with the principles of the present disclosure.

FIG. 16B is an enlarged cross-sectional detail view illustrating the arrangement of FIG. 16A in a coupled condition.

FIG. 17A is an enlarged cross-sectional detail view illustrating another exemplary arrangement for attaching a mat to a frame in accordance with the principles of the present disclosure.

FIG. 17B is an enlarged cross-sectional detail view illustrating the arrangement of FIG. 17A in a coupled condition.

FIG. 18A is an enlarged cross-sectional detail view illustrating yet an exemplary arrangement for attaching a mat to a frame in accordance with the principles of the present disclosure.

FIG. 18B is an enlarged cross-sectional detail view of the arrangement of FIG. 18A taken along line 18B-18B.

FIG. 19 is a perspective view of illustrating the assembly of another exemplary embodiment of a mat in accordance with the principles of the present disclosure.

FIG. 20 is a perspective view of the mat of FIG. 20, illustrating panels joined together.

FIG. 21A is an enlarged cross-sectional detail view illustrating an exemplary arrangement for selectively securing a tube in accordance with the principles of the present disclosure.

FIG. 21B is an enlarged cross-sectional detail view illustrating the arrangement of FIG. 21A with the tube in an open condition.

FIG. 22 is an enlarged cross-sectional detail view illustrating another exemplary arrangement for selectively securing a tube in accordance with the principles of the present disclosure.

FIG. 23 is a perspective view of an exemplary ornamental design of a mat in accordance with the principles of the present disclosure.

FIG. 24 is a top plan view of the mat of FIG. 23.

FIG. 25 is a front elevation view of the pat of FIG. 23, the rear elevation view being the same.

FIG. 26 is a right-side view of the pat of FIG. 23, the left side view being the same.

### DETAILED DESCRIPTION

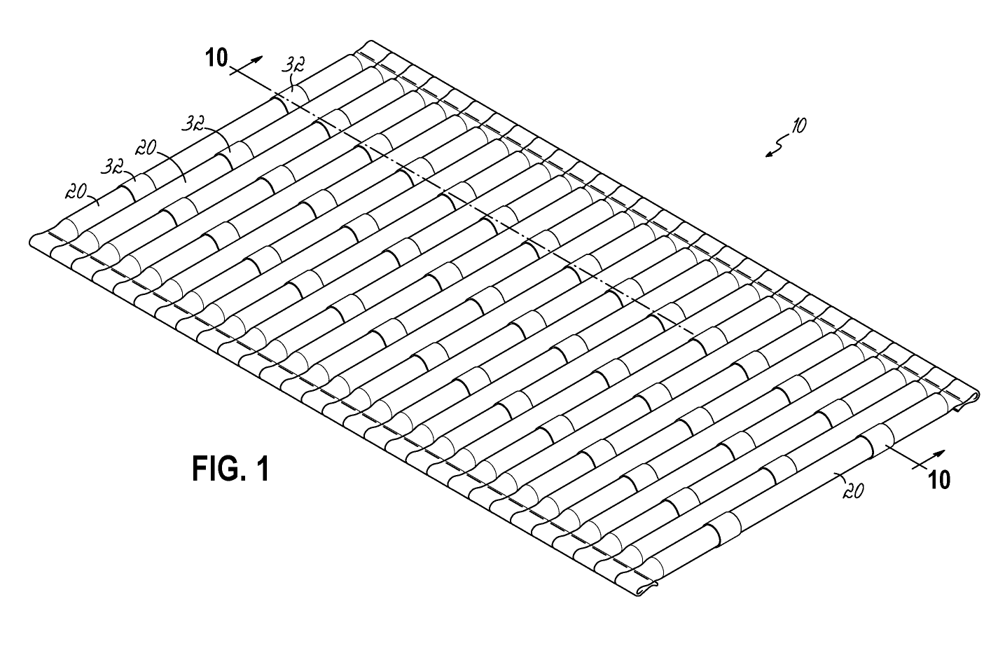

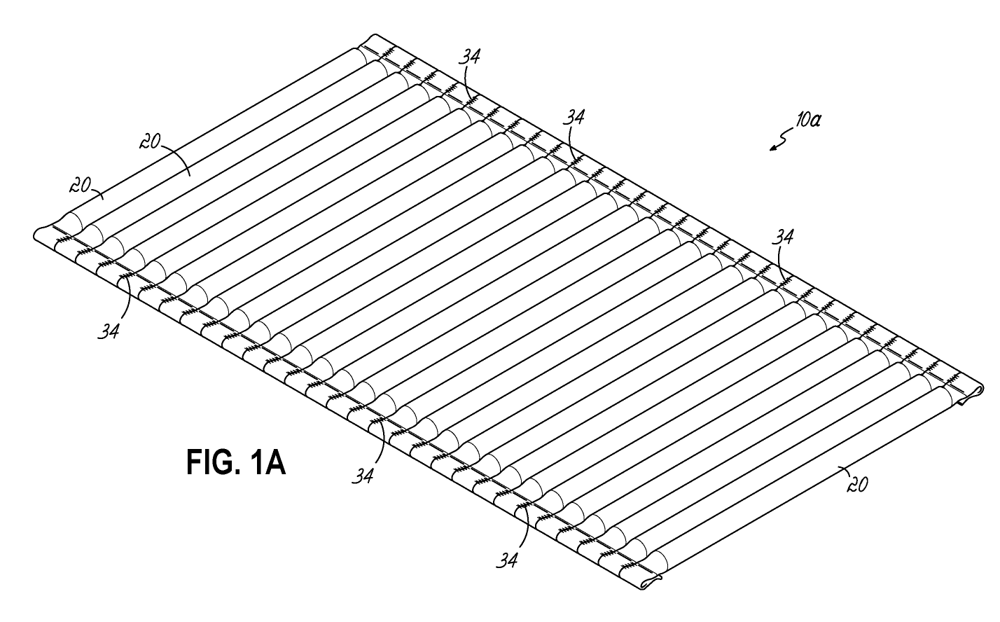

FIGS. 1-3 illustrate an exemplary embodiment of a mat 10 in accordance with the principles of the present disclosure which may be used to facilitate melting ice and/or snow that has accumulated on surfaces such as sidewalks, steps, decks, entrances to buildings or homes, and various other surfaces where ice and snow can accumulate. In the illustrated embodiment, the mat 10 can be removably received within a frame 12 that, in addition to improving aesthetic appearance, helps to maintain the mat in a desired location when placed on a surface 14 to facilitate the removal of ice and/or snow. The frame 12 defines a peripheral border 16 substantially circumscribing an interior area 18 in which the mat 10 may be received. In the embodiment shown, the frame 12 has a generally rectangular shape and completely circumscribes the area 18 in which the mat 10 will be placed. However, it will be appreciated that various other shapes and configurations may alternatively be used, and that the frame 12 need not completely circumscribe the entire periphery of the mat 10, as may be desired for aesthetic or functional purposes. The mat 10 may be coupled with the frame 12, such as by using various coupling mechanisms described below, or the mat 10 may simply be laid within the interior area 18 defined by the frame 12.

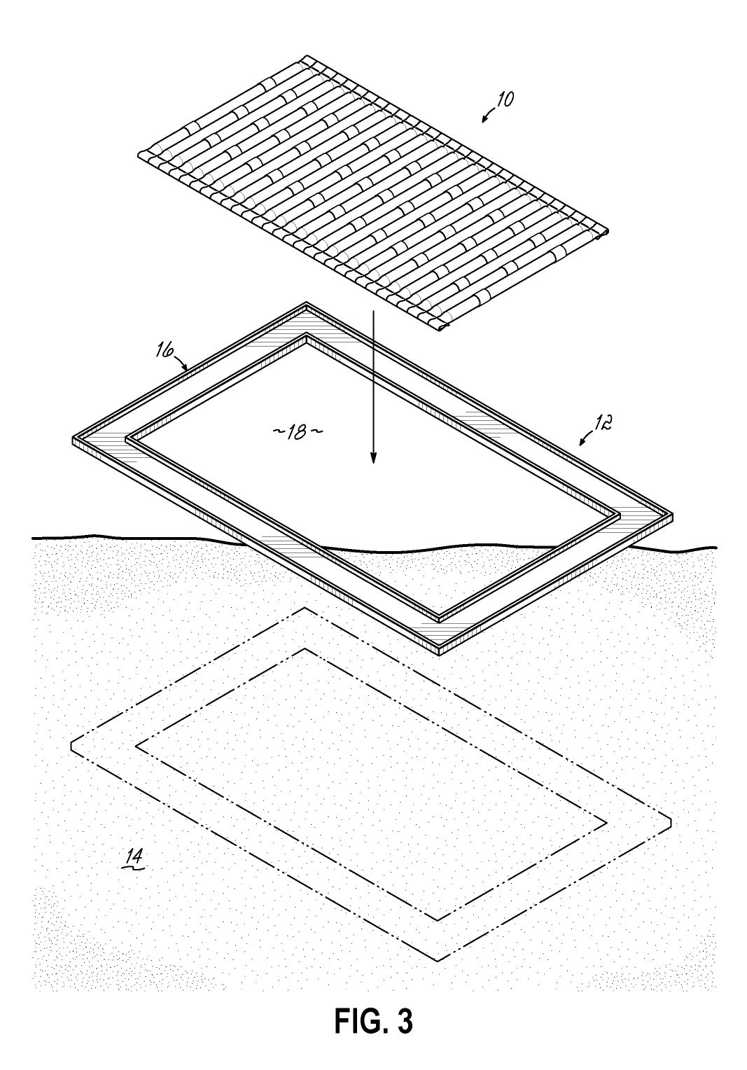

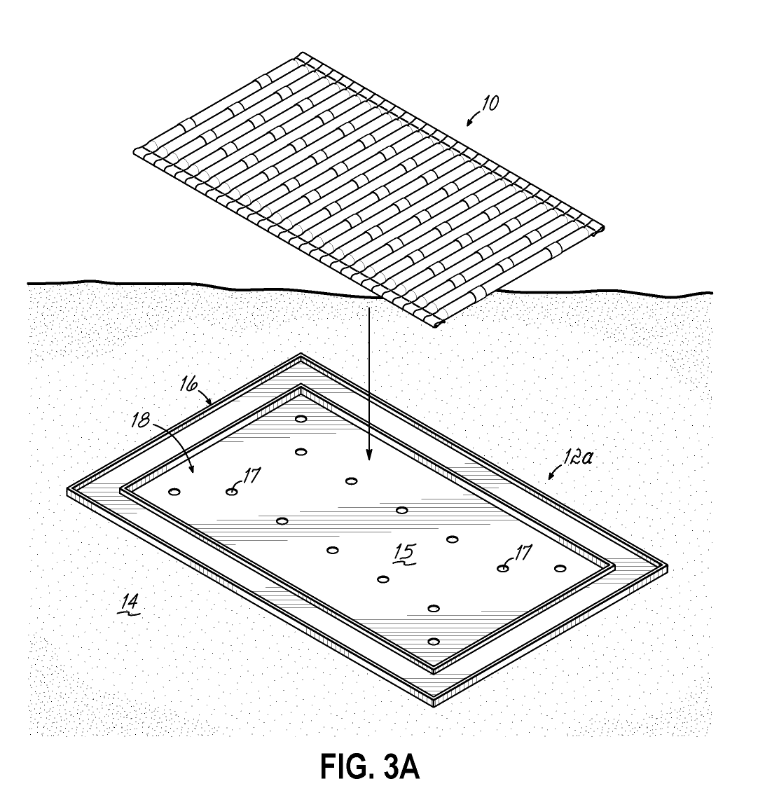

In the embodiment depicted in FIG. 3, the mat 12 does not include any structure corresponding to the interior area 18, whereby a substantial portion of the mat 10 will be in direct contact with a ground surface, or any accumulated ice or snow that may be on the ground surface before the mat 10 is applied. FIG. 3A depicts an another exemplary frame 12a, similar to frame 12 shown and described with respect to FIGS. 1-3, but wherein the frame 12a includes a bottom wall 15 bounded by the peripheral border 16 an corresponding to interior area 18. One or more apertures 17 may be formed in the bottom wall 15 to facilitate draining of any liquid that may accumulate within the interior area 18.

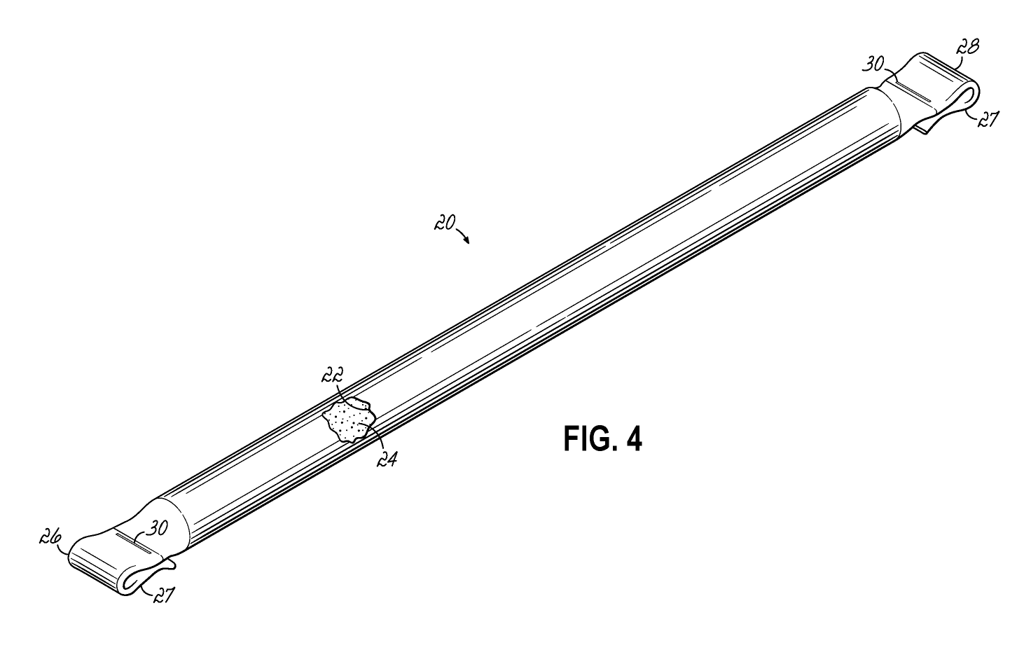

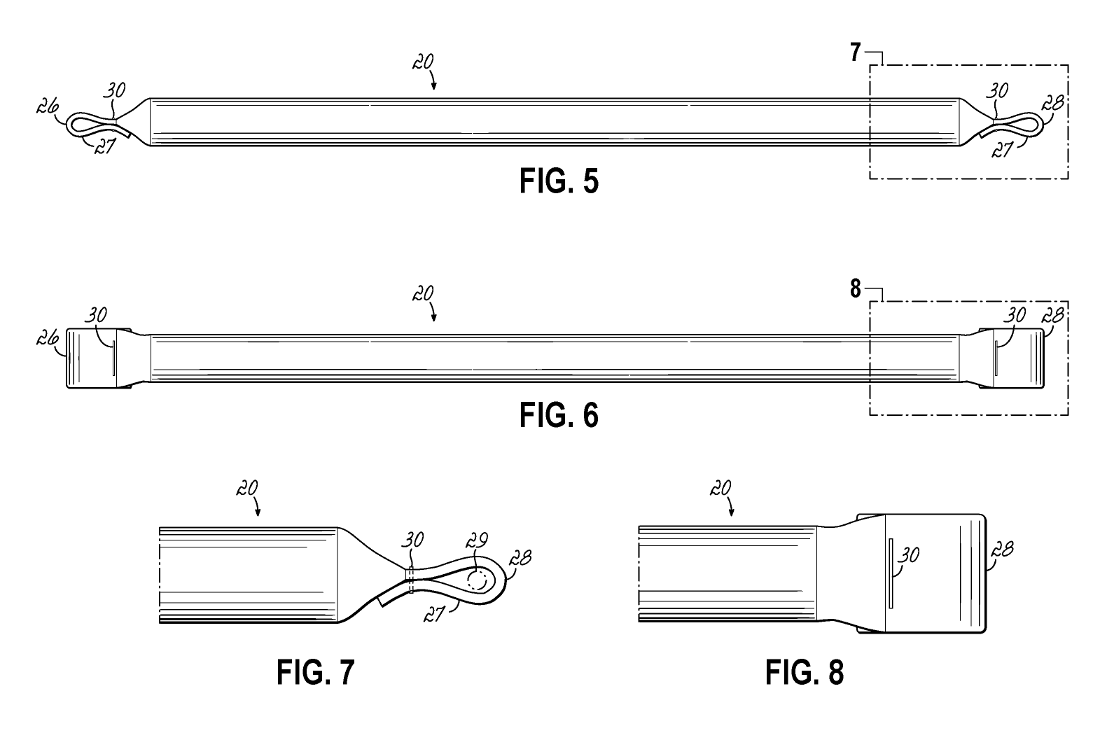

With continued reference to FIG. 1, and referring further to FIGS. 4-10, the exemplary mat depicted in FIG. 1 comprises a plurality of elongate tubes 20, wherein each tube 20 defines a respective chamber 22 for receiving a melting composition 24 therein. The tubes 20 may be formed from textile material such as nylon 6, nylon 6/6, or any other material suitable for containing the melting composition 24 and also allowing the melting composition 24 to act upon snow and/or ice when the mat 10 comes in contact with snow and/or ice. The material for the tubes 20 may also be selected to absorb moisture resulting from the melting ice and snow, such as by wicking action, and to dry quickly in the ambient environment once melting is complete. The wicking action of the material facilitates distributing moisture around the mat 10 so that the melting composition 24 is more effectively activated. After the ice and snow have been melting, the wicking action draws moisture away from the melting composition 24, helping to preserve the melting composition 24 until it is needed again to melt ice and snow.

The ice and snow melting composition 24 may comprise one or more of sodium chloride, calcium chloride, magnesium chloride, potassium chloride, urea, sodium acetate, ammonium nitrate, or ammonium sulfate, individually or in any combination. Alternatively, the melting composition 24 may comprise any other material suitable to facilitate melting ice and snow that comes in contact with the surface of the mat structure. After the melting composition 24 has been received within the interior chambers 22 defined by the tubes 20, one or both ends 26, 28 of the tubes 20 may be closed off and secured by any suitable closure structure 30 or methods. For example, the respective ends 26, 28 of each tube 20 may be folded over themselves and secured such as by stapling, stitching, gluing, heat sealing, or clamping the ends of the tubes, as generally depicted in FIGS. 4-8.

In the embodiment depicted in FIGS. 4-8, the ends 26, 28 of the tubes 20 may be folded so as to form loops 27 at the respective ends 26, 28. The formed loops 27 may be used to facilitate securing adjacent tubes 20 together and/or to couple the mat 10 with a frame 12. For example, a plurality of tubes 20 may be secured to one another in a generally parallel arrangement by an elongate member 29, such as a rope, cord, rod, or other similar structure, to form the mat 10. The elongate member 29 may also be used to couple the mat 10 to the frame 12, for example by engaging the elongate member 29 with appropriate structure on the frame 12.

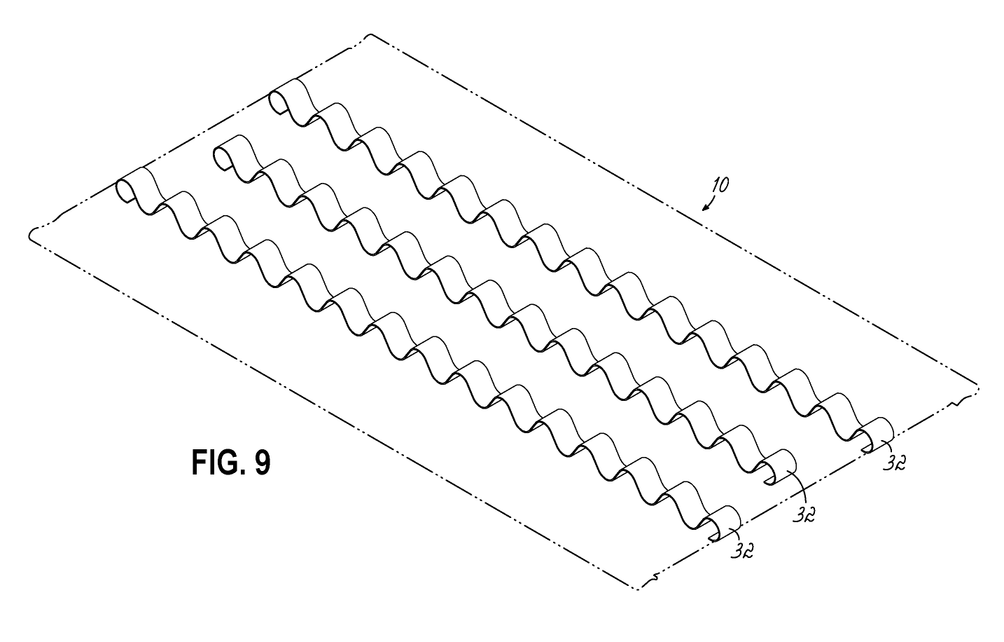

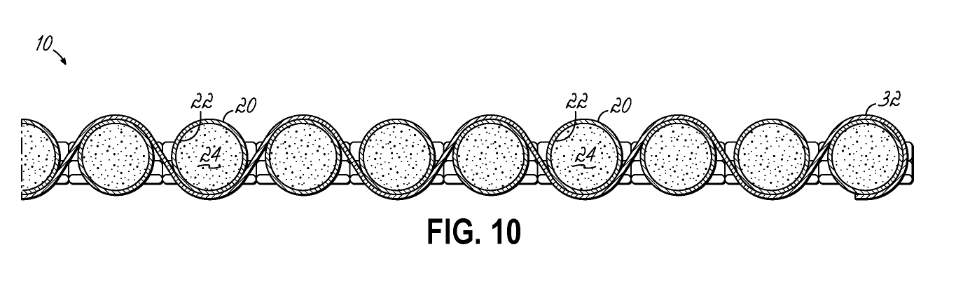

In another embodiment illustrated with reference to FIGS. 1-3, the plurality of tubes 20 are arranged adjacent one another in a generally parallel arrangement, and are coupled together by one or more bands 32 arranged in an over-under fashion, as generally illustrated in FIGS. 9-10. The bands 32 may be secured to one or more of the tubes 20 such as by stitching, stapling, gluing, heat sealing, clamping, or any other suitable method. In yet another embodiment, illustrated with reference to FIG. 1A, tubes 20 may be arranged adjacent one another in a generally parallel manner and coupled together by joining the ends 26, 28 of adjacent tubes 20, such as by stitching 34. While the ends 26, 28 are shown and described with reference to FIG. 1A as being joined by stitching 34, it will be appreciated that ends 26, 28 may alternatively be joined by stapling, gluing, heat sealing, clamping, or by any other suitable method, to form a mat 10a similar to mat 10 described above with respect to FIG. 1.

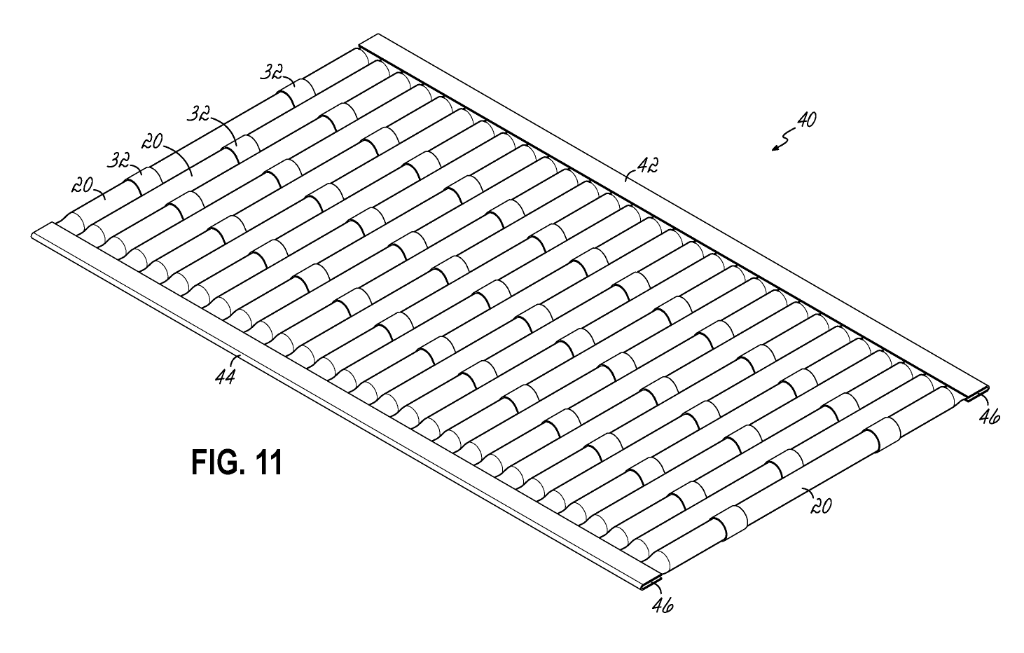

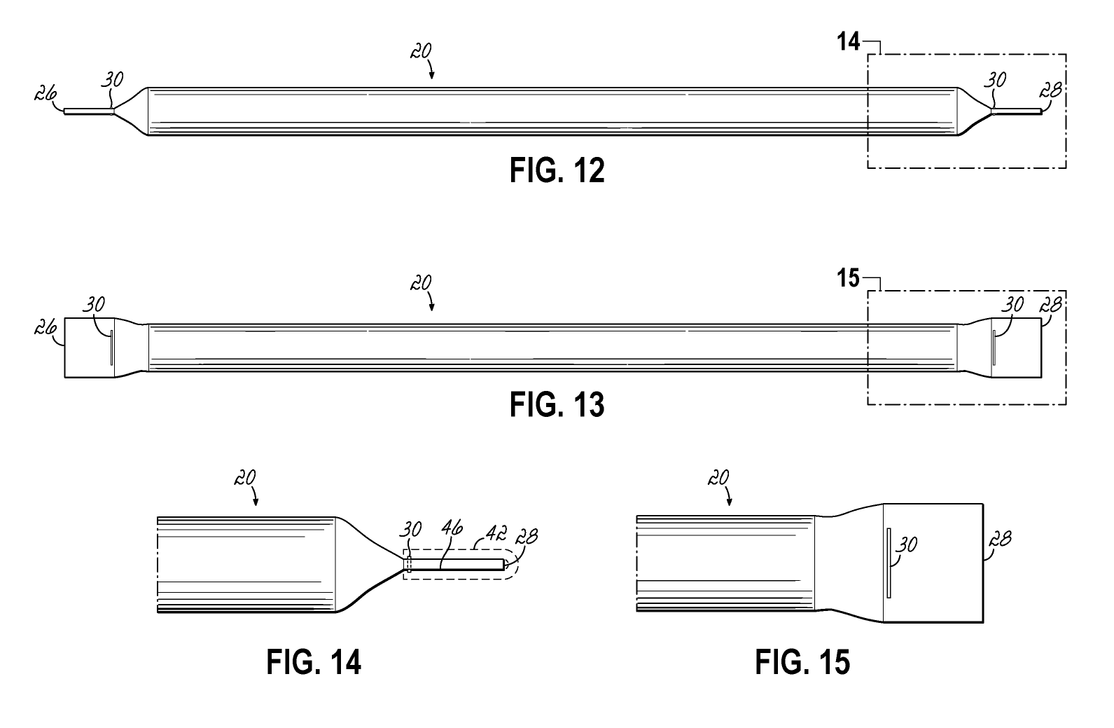

FIGS. 11-15 depict another exemplary mat 40 in accordance with the principles of the present disclosure. The mat 40 is generally similar to the mat 10 discussed above with respect to FIGS. 1-10, but may alternatively, or in addition, include closure/joining structure 42, 44 coupled with respective ends of a plurality of the tubes 20. In accordance with one aspect, the closure/joining structure 42, 44 may comprise a textile or other flexible material that may be folded over itself to define a space 46 for receiving distal ends 26, 28 of the respective tubes 20 therebetween. The closure/joining structure 42, 44 may be secured to the respective ends 26, 28 of the tubes such as by stapling, stitching, gluing, heat sealing, clamping or any other suitable method. In this embodiment, the distal ends 26, 28 of the tubes 20 need not be folded over one another, but may instead simply be flattened and inserted into the space 46 defined by the closure/joining structure 42, 44.

While the closure/joining structure 42, 44 is shown and described in FIGS. 11 and 14 as being folded over itself to define space 46 for receiving ends 26, 28 of tubes 20, it will be appreciated that closure/joining structure 42, 44 may alternatively comprise a strip of edging material to which ends 26, 28 of tubes 20 may be joined, such as by stapling, stitching, gluing, heat sealing, clamping, or any other suitable method, without being folded over itself. Alternatively, the closure/joining structure 42, 44 may itself be configured to secure the open ends 26, 28 of the tubes 20, or the closures/joining structure 42, 44 may be used in combination with separate closures applied to the respective distal ends 26, 28 of the tubes 20 in a manner similar to that discussed above.

In another aspect, the closure/joining structure 42, 44 may be a part of a frame 12, or may itself be used as a frame 12 that can be removably coupled with the mat 40. In one embodiment, the closure/joining structure 42, 44 may comprise a sufficiently rigid material, such as molded or extruded polymeric material having a generally C-shaped cross-section, whereby the closure/joining structure 42, 44 serves as a clip or clamp that may be applied to the distal ends 26, 28 of the plurality of tubes 20. In another embodiment, tubes 20 secured by at least one closure/joining structure 42, 44 may be secured such that the respective chambers 22 defined by the tubes 20 may be accessed by removing the closure/joining structure 42, 44 to facilitate replacing and/or refilling melting composition 24, as may be desired.

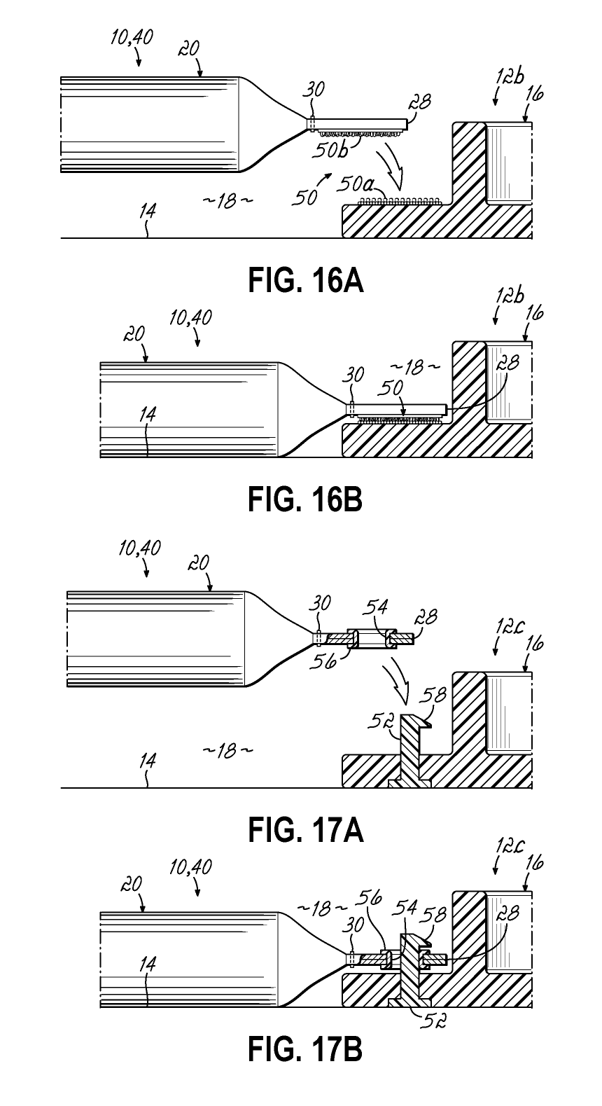

A mat 10, 40 in accordance with the principles of the present disclosure may be coupled with a frame 12 in any suitable manner that facilitates selective attachment and removal of the mat 10, 40 as may be desired. FIGS. 16A and 16B illustrate an exemplary embodiment wherein a mat 10, 40 may be coupled with a frame 12b with a hook-and-loop type fastening mechanism 50. In the embodiment shown, one of the hook-and-loop mechanisms 50a may be affixed to a portion of the frame 12b, and the other hook-and-loop mechanism 50b may be affixed to a portion of a mat 10, 40, such as at distal ends of one or more of the plurality of tubes 20, whereby the mat 10, 40 may be selectively coupled with the frame 12b and may be removed when desired. FIGS. 17A and 17B illustrate another exemplary arrangement for facilitating the selective coupling of a mat 10, 40 with a frame 12b. In this embodiment, the frame 12c includes a post 52 and the mat 10, 40 includes an aperture 54 which may be received over the post 52 to removably secure the mat 10, 40 to the post 52. In the embodiment shown, the aperture 54 is provided by a grommet 56 attached to a distal end of one or more of the plurality of tubes 20 and the post 52 includes a tapered tine 58 which helps to keep the mat 10, 40 secured to the frame 12c when the grommet 56 is placed over the post 52, as depicted in FIG. 17B.

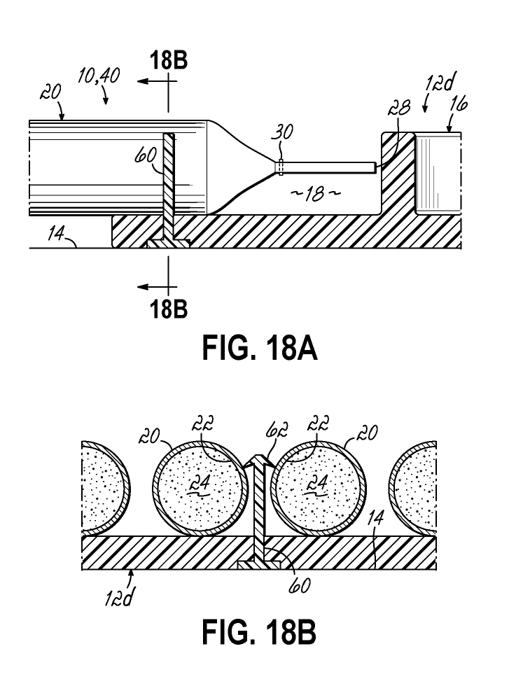

FIGS. 18A and 18B illustrate yet another exemplary arrangement for selectively removably coupling a mat 10, 40 to a frame 12d. In this embodiment, one or more posts 60 may be provided on a portion of the frame 12d at a position to be received between adjacent tubes 20 of a mat structure similar to that described above with respect to FIG. 1. The post 60 may include one or more tines 62 proximate a distal end thereof to facilitate retaining the mat 10, 40 on the frame 12d. While various exemplary arrangements have been described and illustrated herein for selectively removably securing a mat to a frame, it will be appreciated that various other structure and methods for removably securing a mat to a frame may alternatively be used.

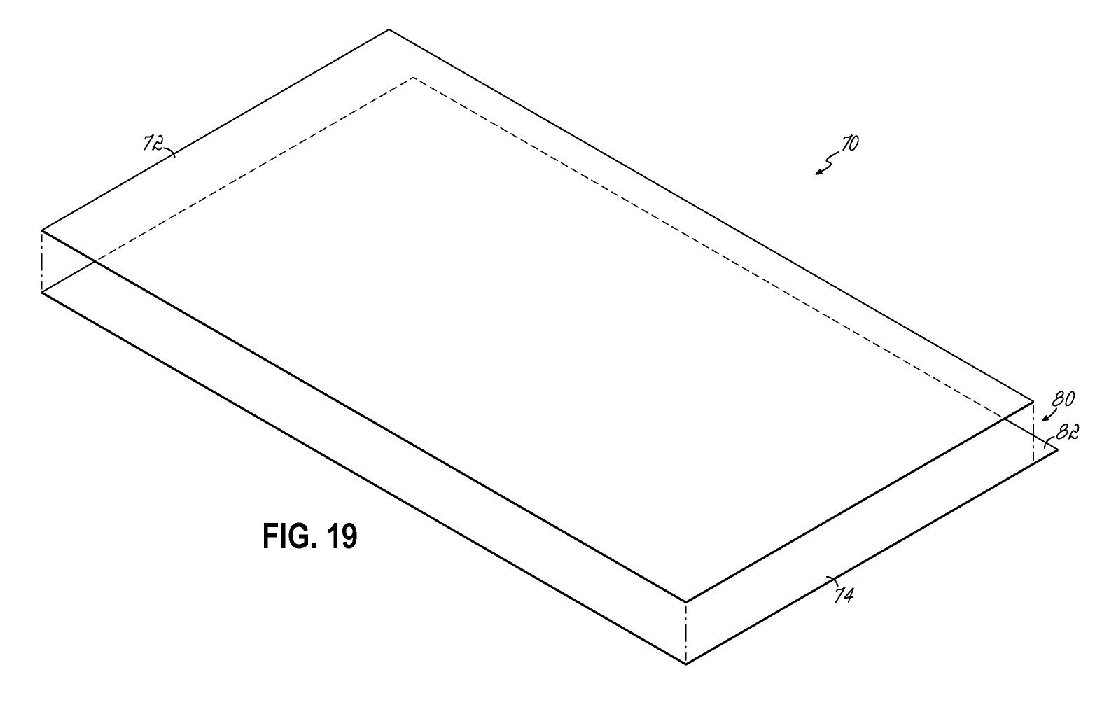

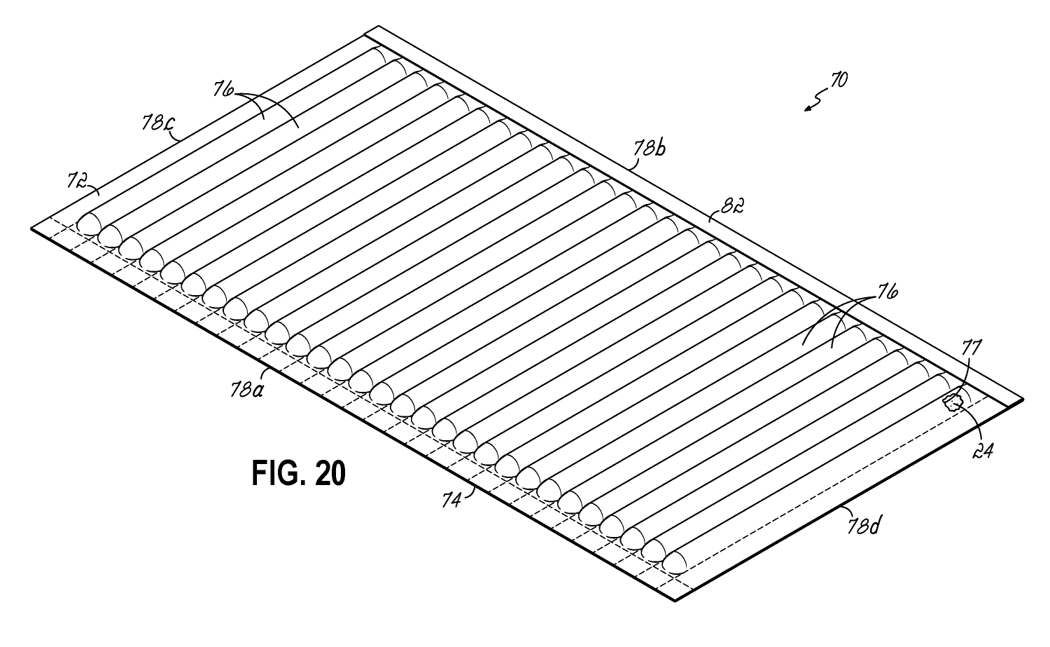

FIGS. 19 and 20 depict another exemplary embodiment of a mat 70 in accordance with the principles of the present disclosure. In this embodiment, the mat 70 comprises at least two confronting panels 72, 74 of material that may be joined together such as by stapling, stitching, gluing, heat sealing, clamping, or any other suitable method to define a plurality of adjacent tubular structures 76 defining respective interior chambers 77 for receiving melting composition 24, as depicted in FIG. 20. For example, the confronting panels 72, 74 may be joined along peripheral side edges 78a, 78b, 78c, 78d of the panels 72, 74 and along spaced apart portions of the panels 72, 74 that are substantially parallel to an edge of the panels 72, 74 to define the generally tubular structures 76. In one aspect, one or more of the side edges 78a, 78b, 78c, 78d of the panels 72, 74 may be left free from joining to thereby define an open side 80 that facilitates filling and/or refilling the chambers 77 defined by the respective tubular structures 76. In this regard, one of the confronting panels 74 may be longer in at least one dimension than the other panel 72 so that a closure flap 80 may be formed by folding the material defined by the additional length over the open end 82 of the mat structure.

In the embodiment shown, the panels 72, 74 comprise separate sheets of material, however, it will be appreciated that the confronting panels 72, 74 may alternatively be formed by folding a single sheet of material over itself to define the confronting panels 72, 74. After melting composition 24 has been received in the respective chambers 77, the open side 80 may be sealed by stitching, stapling, gluing, heat sealing, clamping, or by any other suitable method. Alternatively, the open side 80 may be secured with a separate closure that permits reopening of the open side 80 of the mat 70 to facilitate replacing or refilling the respective chambers 77 with melting composition 24, as may be desired. It will be appreciated that a mat 70 as described above, or any other mat in accordance with the principles of the present disclosure, may be coupled with a frame 12 in a manner similar to those described above with respect to FIGS. 16A-18B, or by any other suitable method.

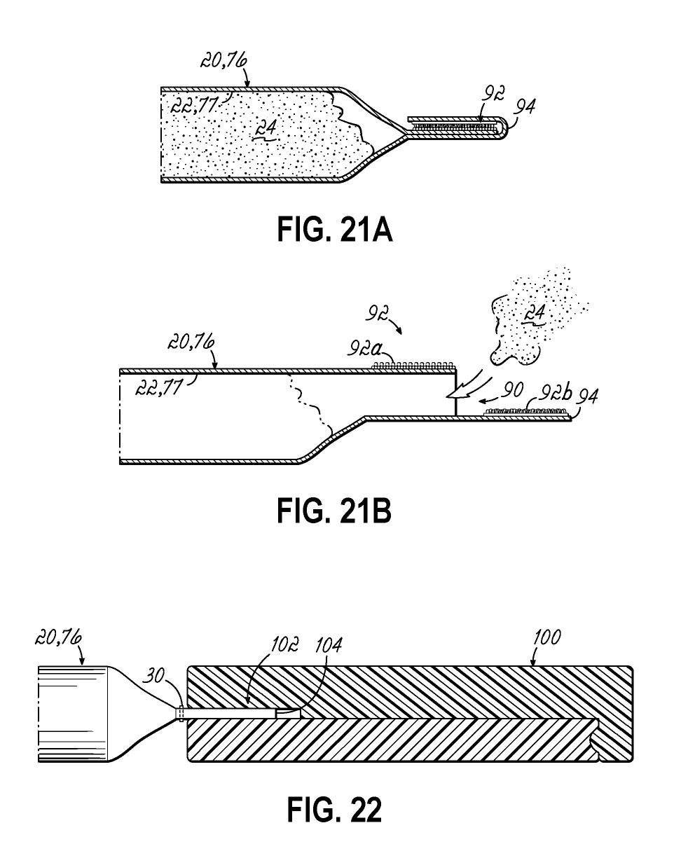

FIGS. 21A and 21B illustrate an exemplary embodiment wherein an open end 90 of one or more of the tubes 20, 76 may be selectively opened and closed to facilitate replacing or refilling the interior chambers 22, 77 with melting composition 24. In this embodiment, a hook-and-loop type closure 92, 92a, 92b is provided on the distal end 94 of one or more of the tubes 20, 76, whereby the closure 92 may be opened to facilitate the removal or replenishment of melting composition 24 through the open end 90 communicating with the interior chamber 22, 77. Mats having tubes 20 with open ends 90 that may be selectively opened and closed to facilitate replacing or refilling the interior chambers 22, 77 as described above, or any other mat in accordance with the principles of the present disclosure, may be coupled with a frame 12 in a manner similar to those described above with respect to FIGS. 16A-18B, or by any other suitable method.

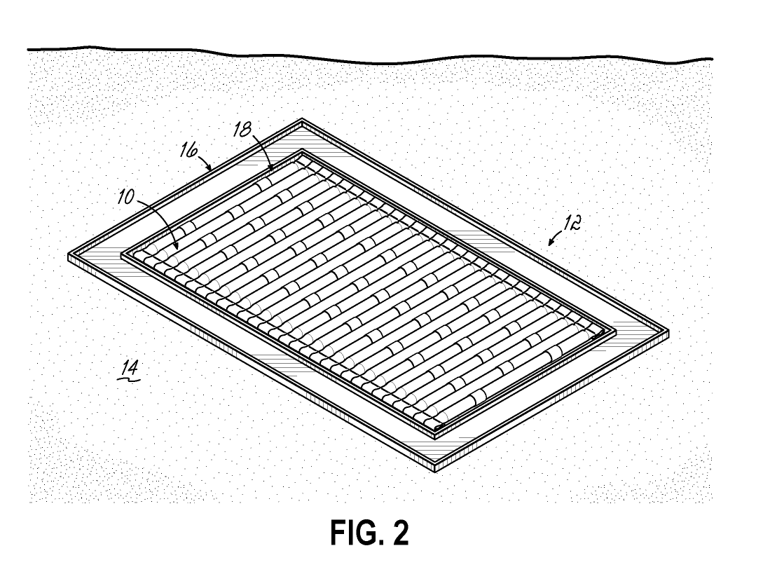

FIG. 22 illustrates another exemplary embodiment wherein a portion of a frame 100 similar to the frame 12 generally depicted in FIGS. 2-3 defines clamping structure 102 for selectively capturing a distal end 104 of one or more tubes 20, 76 of the mat structure. In the embodiment shown, a portion of the frame 100 proximate the interior area defines a clamping portion 102 for receiving a distal end 104 of one or more tubes 20, 76 therein. It will be appreciated that a mats having as described above, or any other mat in accordance with the principles of the present disclosure, may be coupled with a frame 12 in a manner similar to those described above with respect to FIGS. 16A-18B, or by any other suitable method.

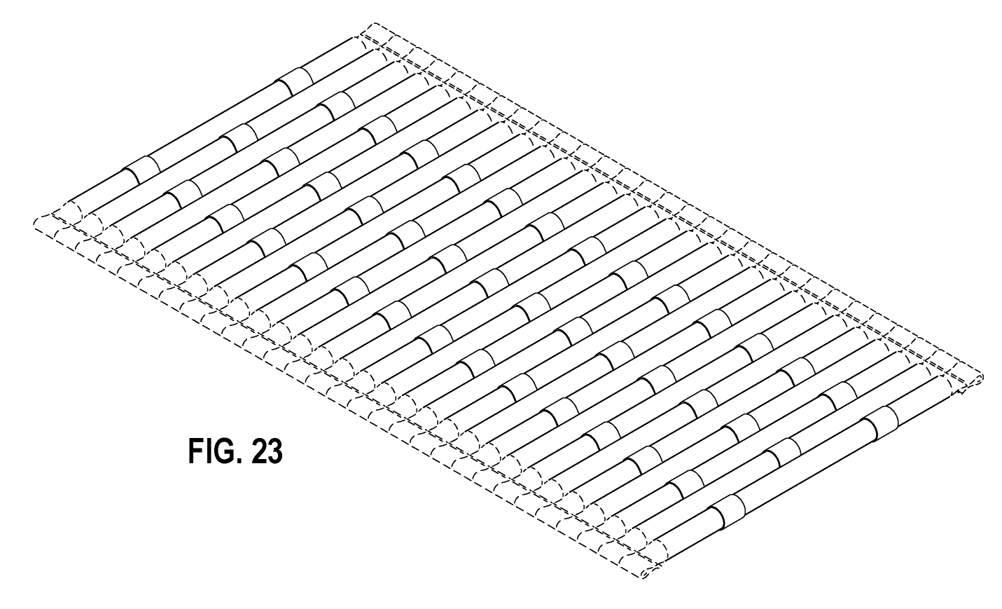

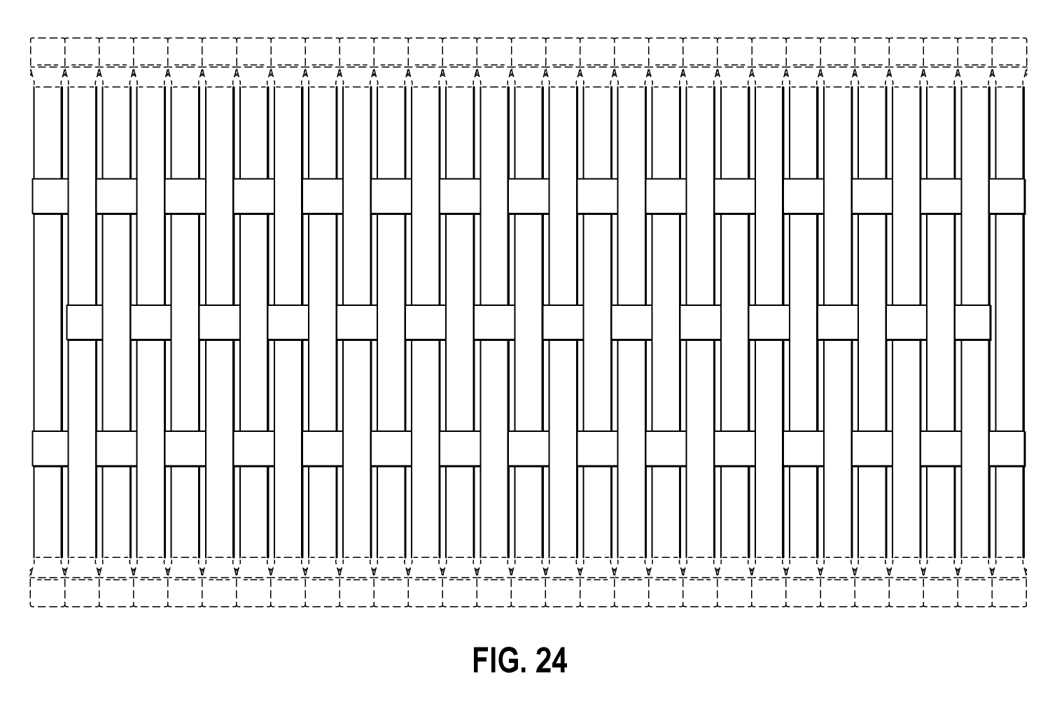

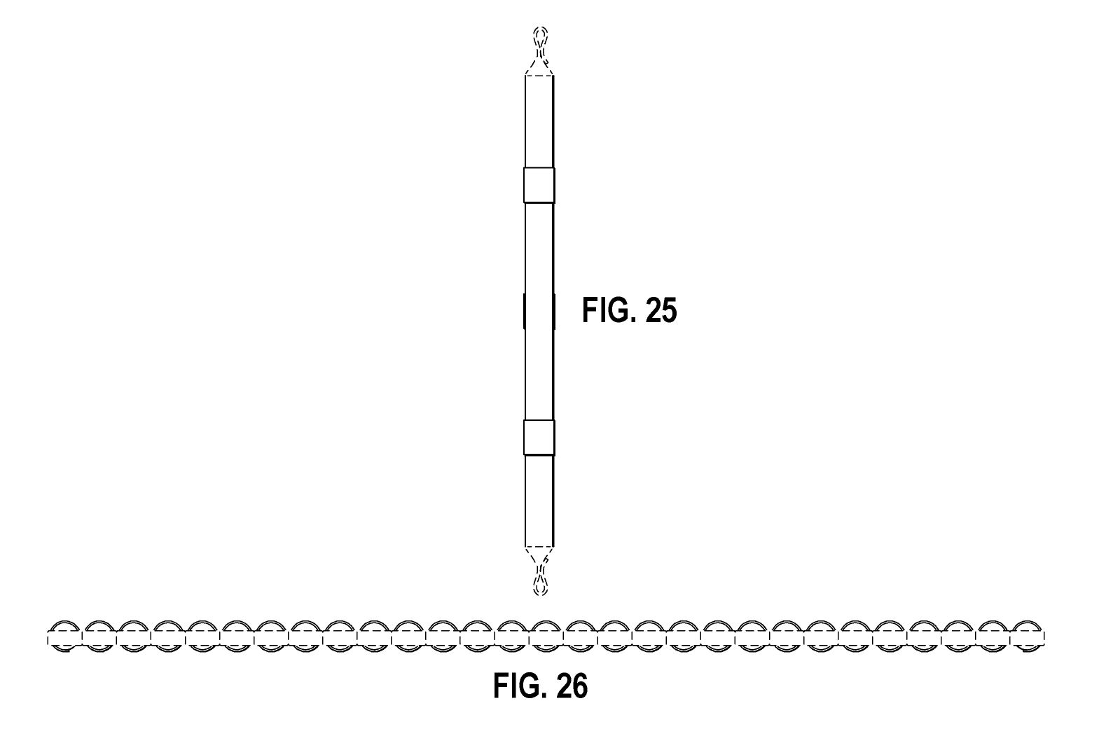

FIGS. 23-26 depict various views of the ornamental design of an exemplary mat in accordance with the principles of the present disclosure.

While the present invention has been illustrated by a description of various embodiments, and while these embodiments have been described in considerable detail, it is not intended to restrict or in any way limit the scope of the appended claims to such detail. The various features shown and discussed herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A surface covering for melting ice or snow, comprising:
opposing panels of textile material joined together to define a mat structure having plurality of adjacent elongate chambers; and
a melting composition disposed in the plurality of chambers.

2. The surface covering of claim 1, wherein the opposing panels are joined together by stitching the panels.

3. The surface covering of claim 1, wherein the opposing panels are formed by folding a single sheet of textile material over itself.

4. The surface covering of claim 1, wherein the textile material is configured to wick moisture formed by melting snow or ice, and to distribute the moisture around the mat structure.

5. The surface covering of claim 1, wherein at least one of the plurality of chambers is selectively openable and closable to facilitate filling and refilling the at least one chamber.

6. The surface covering of claim 1, further comprising:
a frame comprising a peripheral border substantially circumscribing an interior area;
the mat structure removably received within the interior area of the frame.

7. The surface covering of claim 6, wherein the mat is removably coupled with the frame.

8. An apparatus for melting ice or snow, the apparatus comprising:
a frame comprising a peripheral border substantially circumscribing an interior area;
a mat removably received within the interior area of the frame, the mat comprising:
a textile material defining at least one elongate chamber, and
a melting composition disposed in the at least one chamber.

9. The apparatus of claim 8, wherein the mat is removably coupled with the frame.

10. The apparatus of claim 8, wherein the mat comprises a plurality of elongate tubes, each tube defining a respective elongate chamber for receiving the melting composition therein.

11. The apparatus of claim 8, wherein the mat comprises opposing panels of material joined together to define a plurality of adjacent elongate chambers.

12. The apparatus of claim 11, wherein the opposing panels are joined together by stitching the panels.

13. The apparatus of claim 8, wherein the mat further comprises:
an opening communicating with the at least one elongate chamber; and
a closure cooperating with the opening and being adjustable between a first configuration wherein providing access to the elongate chamber through the opening, and a second configuration closing off the chamber.

14. The apparatus of claim 8, wherein the frame is resilient whereby the frame can be folded or rolled into a compact configuration.

15. The apparatus of claim 8, wherein the frame further includes a support surface generally corresponding to the interior area circumscribed by the border, the support surface receiving the mat thereon when the mat is coupled with the frame.

16. The apparatus of claim 15, further comprising at least one aperture through the support surface.

17. The apparatus of claim 1, wherein the textile material is configured to wick moisture formed by melting snow or ice, and to distribute the moisture around the mat.
